(19) United States
(12) Patent Application Publication
(10) Pub. No.: US 2013/0208517 A1
(43) Pub. Date: Aug. 15, 2013

(54) Method of Damping Harmonic Output

(71) Applicants: Hanif Mashal, Carpinteria, CA (US); Souleman Njoya Motapon, Manchester, CT (US); Aniket Subhash Patke, Ventura, CA (US)

(72) Inventors: Hanif Mashal, Carpinteria, CA (US); Souleman Njoya Motapon, Manchester, CT (US); Aniket Subhash Patke, Ventura, CA (US)

(73) Assignee: Clipper Windpower, Inc., Carpinteria, CA (US)

(21) Appl. No.: 13/399,441

(22) Filed: Feb. 17, 2012

Related U.S. Application Data
(60) Provisional application No. 61/599,220, filed on Feb. 15, 2012.

(51) Int. Cl. H02M 1/12

(52) U.S. Cl. 363/40

(57) ABSTRACT

A method of damping harmonic output of an inverter is provided. The method may receive output phase signals from sensors disposed at an output of the inverter and on an associated electrical grid, filter the output phase signals using a low pass filter configured to extract a fundamental component from the output phase signals, isolate harmonics from the output phase signals based on the extracted fundamental component, and subtract the harmonics from the output phase signals.

### CROSS-REFERENCE TO RELATED APPLICATION

This is a non-provisional U.S. patent application, which claims priority under 35 USC §119(e) to U.S. Provisional Patent Application Ser. No. 61/599,220 filed on Feb. 15, 2012.

### FIELD OF THE DISCLOSURE

The present disclosure generally relates to inverters, and more particularly, relates to the damping of harmonic output in inverters.

### BACKGROUND OF THE DISCLOSURE

Inverters are commonly used to synchronize electrical power that is sourced by some power-generating machine, such as a wind turbine generator, a solar panel system, or the like, with an associated electrical grid. As shown in the conventional inverter system 2 of FIG. 1, for instance, the inverter 4 of a wind turbine 6 may be controlled by a pulse width modulated (PWM) controller 8 and connected to the electrical grid 10 through a set of passive filters 12 and a pad mount transformer (PMT) 14. The passive filters 12 essentially include a set of line reactors 16 and trap filters 18. The line reactors 16 are used to reduce the line current ripples in the electrical output of the inverter 4 prior to reaching the electrical grid 10, while undamped tuned trap filters 18 are used to eliminate switching harmonics in both the voltage and current of the electrical output of the inverter 4. The PMT 14 steps up the voltage output by the inverter 4 prior to connecting the inverter output to the grid 10.

Although passive filters serve to filter the electrical output of an inverter, the passive filters themselves are susceptible to interference caused by surrounding electrical components. Specifically, the trap filters, the step-up transformer and the electrical grid have been found to interact with one another, introducing new resonant frequencies or harmonics that are far below the switching frequency of the inverters. The harmonics, especially in the presence of any voltage or current harmonics having frequencies similar to the new resonant frequencies, may further induce more undesirable conditions such as a severe resonance event, or the like. Such conditions may not only violate regulatory standards and/or compliance requirements, but may potentially damage critical components of the power system as well as cause substantial downtime for the power-generating machine and other downstream equipment.

Several solutions have been used to prevent or compensate for interference conditions. Among the most common solutions, implemented through both baseline designs and retrofit applications, is to add physical damping resistors 20 onto the trap filters 18, as shown in FIG. 2, so as to passively damp any new resonant frequencies. However, due to the relatively large resistance of the added resistors, this solution generates additional heat loads within the inverter system, which further results in losses in both system efficiency and performance. An alternate solution consists of applying an active damping technique which emulates the passive damping characteristics of a physical resistor without actually adding a damping resistor to the system. However, currently existing active damping implementations require new current sensors to be installed in the trap filters. In order to properly make use of the new current sensors, the overall system will additionally need to implement new inputs/outputs for the inverter controller as well as other related electrical components and resources. This further adds to the cost and complexity of the overall system, while also decreasing the reliability of the associated controller.

Accordingly, it would be beneficial to provide a method or a system which alleviates some of the disadvantages associated with conventional inverters damping mechanisms. Specifically, there is a need for a solution which efficiently and effectively damps harmonic output of inverters without introducing significant heat loads or complexity to the overall implementation. Moreover, there is a need for a simple and a more reliable damping solution that can be incorporated into baseline designs and/or retrofitted onto existing applications at minimal cost.

### SUMMARY OF THE DISCLOSURE

In accordance with one aspect of the present disclosure, a method of damping harmonic output of an inverter is provided. The method may receive output phase signals from sensors disposed at an output of the inverter and on an associated electrical grid, filter the output phase signals using a low pass filter configured to extract a fundamental component from the output phase signals, isolate harmonics from the output phase signals based on the extracted fundamental component, and subtract the harmonics from the output phase signals.

In accordance with another aspect of the present disclosure, a method of damping harmonic output of an inverter is provided. The method may receive output phase signals from sensors disposed at an output of the inverter and on an associated electrical grid, estimate trap filter currents based on the output phase signals, isolate harmonics from the output phase signals based at least partially on the estimated trap filter currents, and subtract the harmonics from the output phase signals.

In accordance with yet another aspect of the present disclosure, a system for damping harmonic output is provided. The system may include an inverter having a plurality of output phases, a filter module having line reactors and trap filters in communication with the output phases of the inverter, a plurality of sensors configured to detect at least a voltage of each output phase, and a controller in communication with the sensors and operatively coupled to the inverter. The controller may be configured to isolate harmonics from each output phase signal, and subtract the harmonics from the corresponding output phase signals.

Other advantages and features will be apparent from the following detailed description when read in conjunction with the attached drawings.

### BRIEF DESCRIPTION OF THE DRAWINGS

For a more complete understanding of the present disclosure, reference should be made to the embodiments illustrated in greater detail on the accompanying drawings, wherein:

FIG. 1 is a schematic view of a conventional inverter system of the prior art;

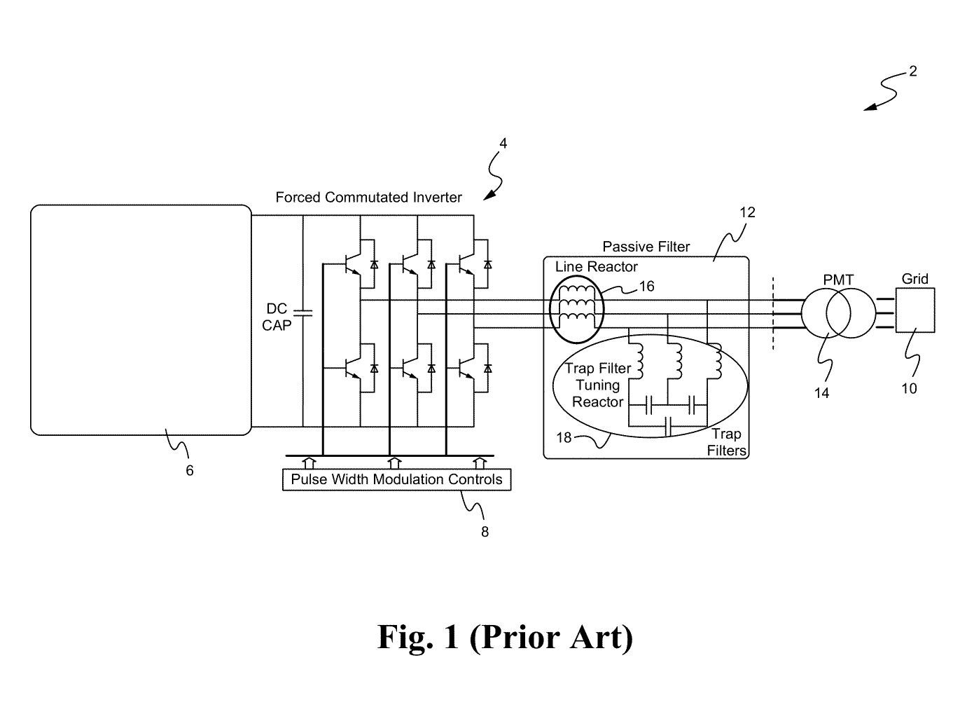

FIG. 2 is a schematic view of a passive filter for a conventional inverter system of the prior art;

FIG. 3 is a schematic view of an exemplary inverter system, in accordance with at least some of the embodiments of the present disclosure;

FIG. 4 is a diagrammatic view of an exemplary method for damping harmonic output of inverters;

FIG. 5 is a diagrammatic view of a passively damped, actively filtered inverter control function;

FIGS. 6 and 7 are graphical views of a simulated comparison between undamped inverter outputs and passively damped, actively filtered inverter outputs;

FIGS. 8 and 9 are graphical views of a tested comparison between undamped inverter outputs and passively damped, actively filtered inverter outputs;

FIG. 10 is a diagrammatic view of an actively damped inverter control function;

FIG. 11 is a schematic view of a single-phase equivalent circuit of an undamped inverter system;

FIG. 12 is a diagrammatic view of a single-phase equivalent control function of the undamped inverter system of FIG. 11;

FIG. 13 is a schematic view of a single-phase equivalent circuit of a passively damped inverter system;

FIG. 14 is a diagrammatic view of a single-phase equivalent control function of an actively damped inverter system corresponding to the passively damped inverter system of FIG. 13; and

FIGS. 15 and 16 are graphical views of a comparison between the passively damped, actively filtered control function of FIG. 5 and the actively damped control function of FIG. 10.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

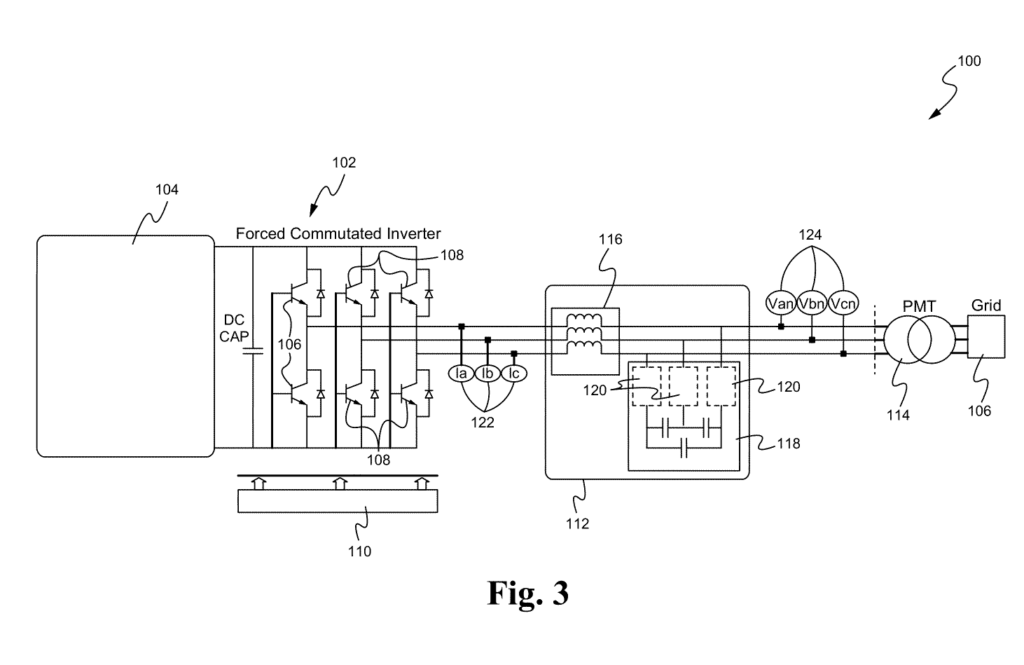

Referring to FIG. 3, an exemplary inverter system 100 is shown, in accordance with at least some of the embodiments of the present disclosure. As shown, the inverter system 100 may include an inverter 102 that is disposed at an output of a power-generating machine 104, such as a multi-phase or a three-phase machine, including a wind turbine generator, a solar panel system, or any other energy source configured to supply electrical power for transmission to an associated electrical grid 106. The inverter 102 may include a plurality of switches 108, such as insulated-gate bipolar transistors (IGBTs), or the like, that may be selectively operated by a controller 110 so as to regulate and synchronize the multi-phase alternating current (AC) output of the power-generating machine 104 with the electrical grid 106.

The inverter system 100 may further include a filter module 112 that is disposed downstream and in communication with the output of the inverter 102, but upstream of a pad mount transformer (PMT) 114 and the electrical grid 106. The filter module 112 may include a plurality of line reactors 116, trap filters 118 and associated filter elements 120 configured to filter and/or provide damping to the synchronized output of the inverter 102. In particular, the line reactors 116 may be configured to reduce line current ripples, while the trap filters 118 may be configured to eliminate any switching harmonics that may reside in the voltage and current signals of the inverter output. Moreover, based on the desired application, the filter elements 120 may be configured with inductors to provide a substantially undamped filter system, or alternatively, may be configured with damping resistors to provide a passively damped filter system. Once the inverter output phase signals are filtered and/or damped by the filter module 112, the PMT 114 may be used to increase or step-up the output voltage to a level suitable for connection to the grid 106.

Still referring to FIG. 3, the inverter system 100 may include a plurality of sensors 122, 124 through which the controller 110 may detect and monitor each output phase of the inverter 102. For example, the inverter system 100 may include a plurality of current sensors 122 that are disposed upstream of the filter module 112, and/or a plurality of voltage sensors 124 that are disposed downstream of the filter module 112. The sensors 122, 124 may also be disposed along a different one of the three phases that are output by the inverter 102. Each of the sensors 122, 124 may electronically communicate and convey current and/or voltage measurements to the controller 110 through input ports provided on the controller 110. Additionally, the sensors 122, 124 may be disposed externally relative to the filter module 112 as typical with existing and conventional inverter systems. As such, the controller 110 may be adapted to communicate not only with sensors 122, 124 of newly installed inverter systems 100, but also with pre-existing sensors 122, 124 of previously installed inverter systems, such as in retrofit applications. Upon receiving measurements provided by the sensors 122, 124, the controller 110 may be configured to use that feedback to control the AC current regulator of the inverter 102 and make any necessary adjustments to the inverter output.

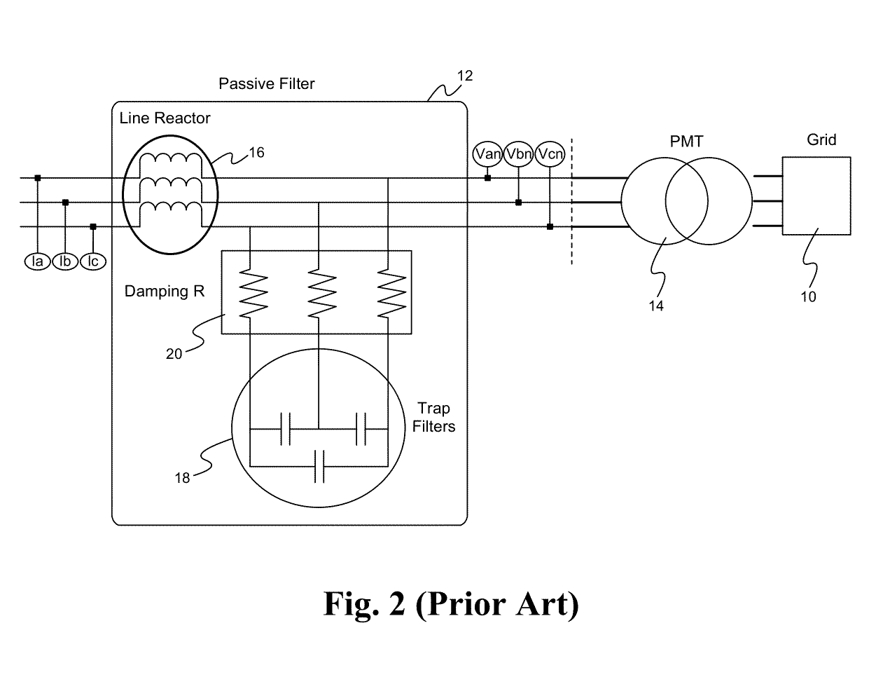

The inverter system 100 of FIG. 3 may generally be configured in one of two configurations. For instance, the inverter system 100 may be configured to perform a combination of both passive damping and active filtering to the output phase signals so as to isolate and extract undesirable harmonics therefrom. In such embodiments, the filter module 112 of the inverter system 100 may employ passively damping filter elements 120, such as resistors, or the like, while the controller 110 may be preprogrammed with algorithms configured to actively filter the output phase signals. The active filtering provided by the controller 110 may serve to minimize or at least substantially reduce the resistance of the damping resistors required by the filter module 112 such that the resulting heat loads are also reduced. Moreover, the active filtering may account for a reduction in the damping resistance of approximately 50% as compared to those employed by the prior art, such as in the design of FIG. 2. For example, the resistance of the damping resistors employed in the filter module 112 may be as low as approximately 0.5Ω, whereas that of the damping resistors 20 currently employed by the prior art may be approximately 1.0Ω. In alternative embodiments, the inverter system 100 may also be configured to employ active damping rather than passive damping in order to isolate and extract undesirable harmonics from the output phase signals. In such embodiments, the filter module 112 of the inverter system 100 may employ undamped filter elements 120, such as inductors, or the like, rather than resistors, while the controller 110 may be preprogrammed with algorithms configured to actively damp harmonic outputs. While only two configurations are discussed, it will be understood that other modifications and/or configurations of the inverter system 100 may be used in accordance with the teachings of the present disclosure.

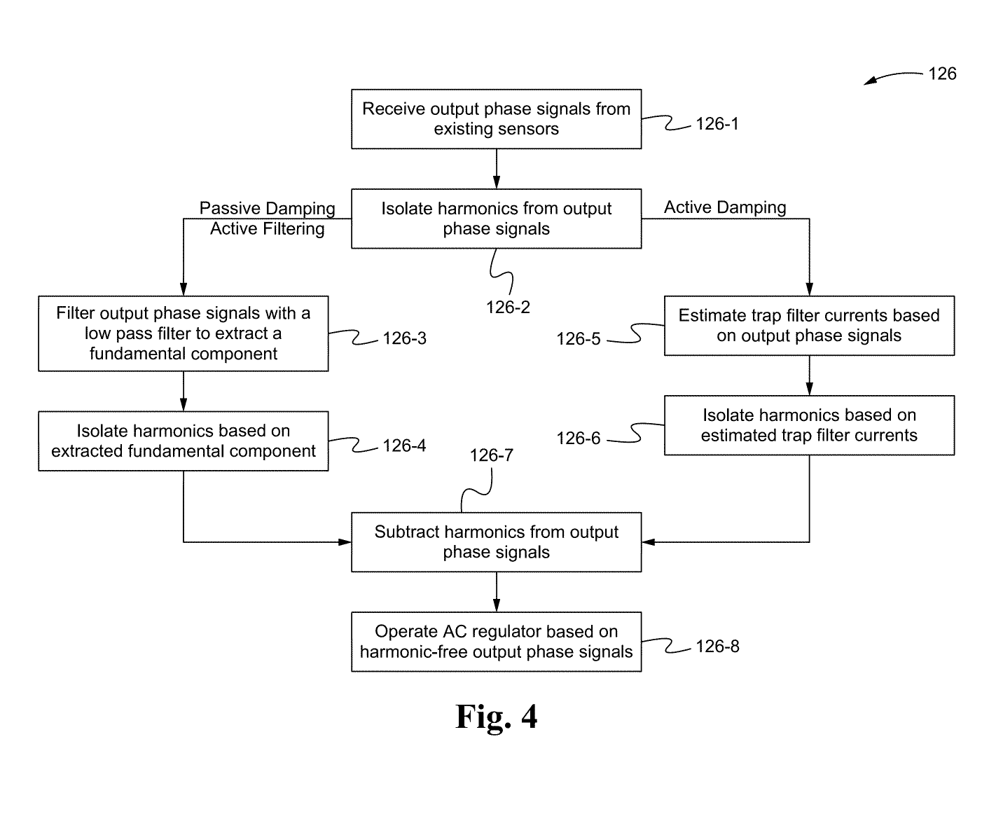

Turning now to FIG. 4, one exemplary algorithm or method 126 by which the controller 110 may be configured to operate is provided. The controller 110 may be implemented using any one or more of a microcontroller, a processor, a microprocessor, and any other suitable electronic device that may be preprogrammed according to the method 126 provided. As shown in an initial and/or an ongoing step 126-1, the controller 110 may be configured to sample, track, read and/or monitor each output phase of the inverter 102 by receiving output phase signals provided by the sensors 122, 124. Each output phase signal that is generated by the sensors 122, 124 may include information pertaining to the AC current or AC voltage that is measured in each phase of the inverter output. In step 126-2, the controller 110 may proceed to isolate any significant level of harmonics that may be present in the output phase signals. Based on the desired application and the configuration of the inverter system 100, the controller 110 may be preprogrammed to accomplish the isolation step 126-2 in one of a number of different ways. For instance, if the filter module 112 of the inverter system 100 in FIG. 3 is configured with passively damping filter elements 120, such as damping resistors, or the like, the controller 110 may be configured to isolate harmonics using a first approach which passively damps and actively filters the output phase signals, as in steps 126-3 and 126-4. Alternatively, if the filter module 112 of the inverter system 100 is configured with undamped filter elements 120, such as inductors, or the like, the controller 110 may be configured to isolate harmonics using a second approach which actively damps the output phase signals, as in steps 126-5 and 126-6.

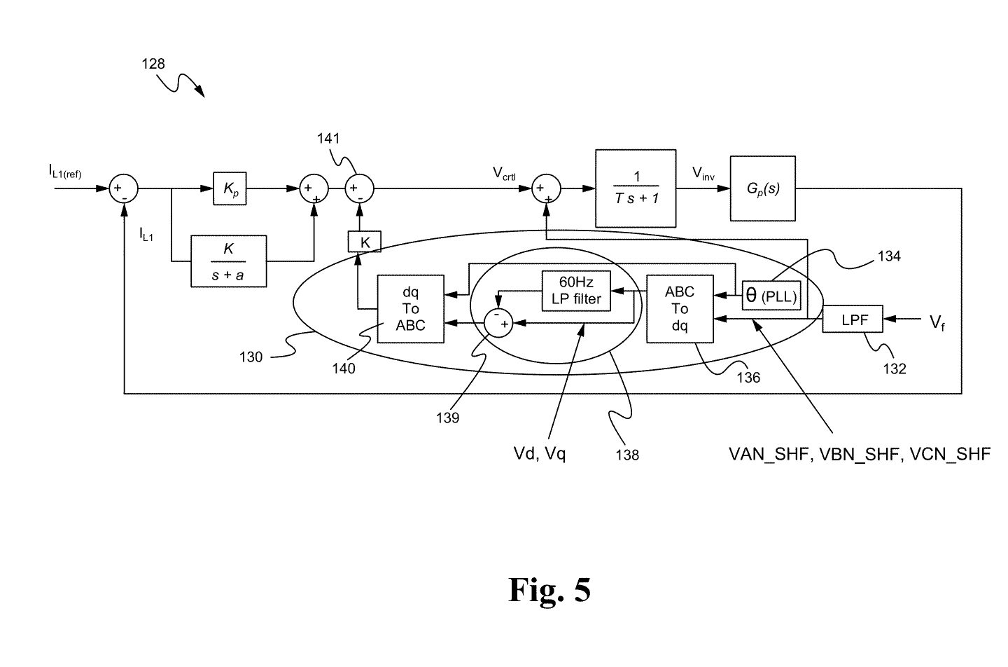

In accordance with the first passively damped and actively filtered approach of FIG. 4, the filter module 112 of the inverter system 110 may be provided with passive damping resistors of substantially reduced resistance, while the controller 110 may generally be configured to filter the output phase signals using a low pass filter in step 126-3, and isolate the harmonics by extracting the fundamental component in step 126-4. More specifically, as shown in FIG. 5, the AC current regulator or inverter control function 128 of the controller 110 may be provided with an active filtering control loop 130 configured to extract only distortions from the output phase signals of the current regulator 128 with a phase shift of 180°. In accordance with step 126-3 of FIG. 4, the output phase voltage signals measured by the sensors 122, 124 may initially be passed through low pass filters 132 and appropriate voltage converters. Once filtered, the output phase signals may be phase-shifted, for example, using a phase-locked loop (PLL) 134, to account for any phase lag that may have been caused by the low pass filters 132. The filtered and phase-shifted output phase signals may additionally be transformed into synchronous direct-quadrature (dq) reference signals within a transform module 136 based on the angle θ=ωt obtained from the PLL 134 so as to simplify calculations that are performed by the controller 110. In accordance with step 126-4 of FIG. 4, the transformed dq reference signals may be passed through a second low pass filter 138, such as a 60 Hz/50 Hz filter, or the like, configured to extract the fundamental component and to leave only voltage harmonics. More specifically, the low pass filter 138 may output only the fundamental component, which may then be subtracted from the dq reference signals V_{d}, V_{q} via the adder 139 of FIG. 5 to result in signals containing purely voltage harmonics. The harmonics may then be fed into a second dq transform module 140 configured to transform the dq reference signals back into harmonic phase signals that are phase-shifted by angle θ=ωt. The active filtering control loop 130 may additionally apply an appropriate gain K to the harmonic phase signals. Based on the stability limit of the controller 110, the gain K may be selected from a range, for example, extending approximately between 1.00 and 1.15. Once the harmonics have been isolated, the controller 110 may be configured to subtract the harmonics from the output phase signals in step 126-7, and operate the AC current regulator 128 based on the harmonic-free output phase signals in step 126-8. More particularly, the harmonics which have been isolated by the adder 139 in step 126-4 may be subtracted from the regulator control signal V_{ctrl} via a second adder 141. The controller 110 may then use the newly adjusted control signal V_{ctrl} to operate the output of the AC current regulator 128 accordingly.

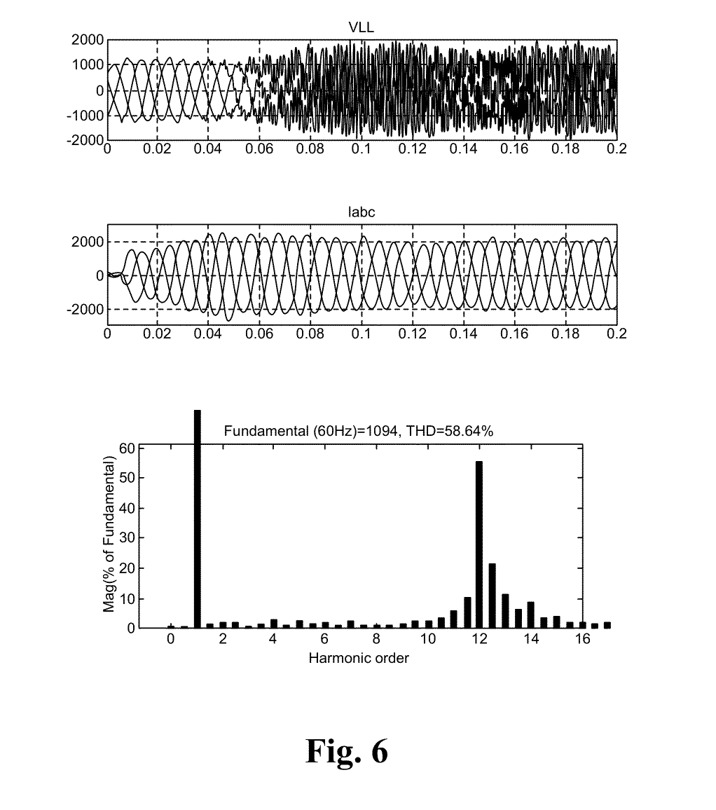

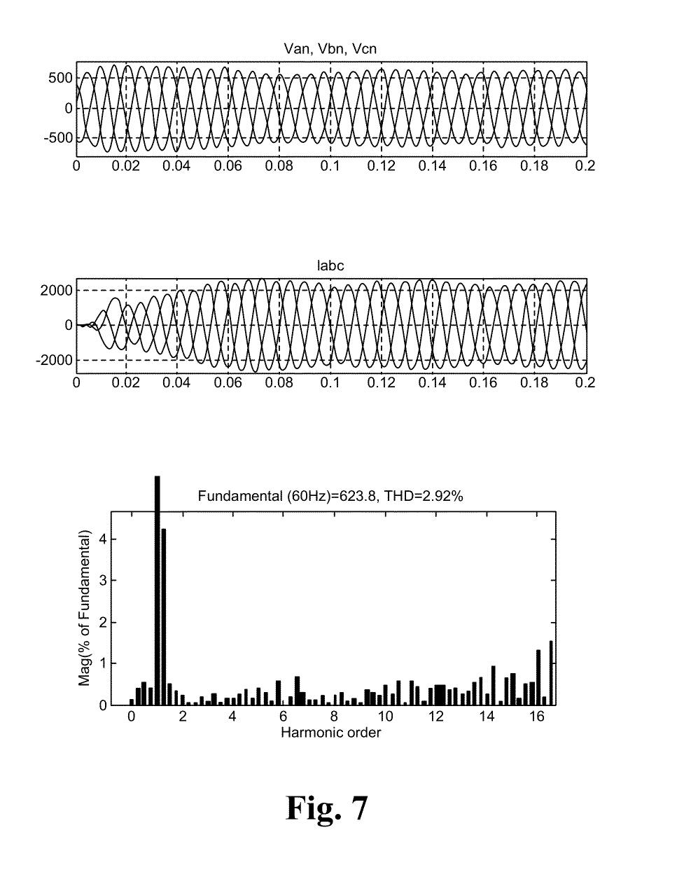

The effectiveness of the first approach to method 126 may be demonstrated using simulated outputs, as shown in FIGS. 6 and 7, for example, of a wind park having approximately twenty power-generating wind turbines. Specifically, the simulated analyses may demonstrate the difference in performance between the power output by an inverter system having undamped trap filters and the power output by an inverter system having the combined passive damping and active filtering of FIG. 4. As shown in FIG. 6, the undamped inverter system may exhibit severe resonance approximately located at the 12th harmonic order caused by interactions between the trap filters of the turbine inverters and the electrical grid. However, as shown in FIG. 7, the power output may be significantly improved by applying a combination of an active filter and a passive, reduced-size damping resistor to the same inverter system. Similarly, the analyses of FIGS. 8 and 9 may illustrate the effectiveness of the first approach to method 126 based on actual tests of a wind park having more than twenty power-generating wind turbines. In particular, FIG. 8 may illustrate the voltage and current output from the wind park prior to applying the passively damped, actively filtered method 126 of FIG. 4, whereas FIG. 9 may illustrate the voltage and current output from the same wind park after applying the passively damped, actively filtered inverter method 126. As shown, the passively damping and actively filtering may prevent the formation of any undesirable resonance between the wind turbines and the grid, and further, may ensure that the quality of the power generated by the wind turbines meet regulatory and other relevant compliance standards, such as the IEEE 519 standard. Moreover, the first approach of method 126 may be capable of damping substantially all harmonics above the fundamental frequency, for instance, 60 Hz/50 Hz, and additionally, may not be dependent on grid parameters, such as those of transformers, feeders, passive filter elements of the associated inverters, and the like.

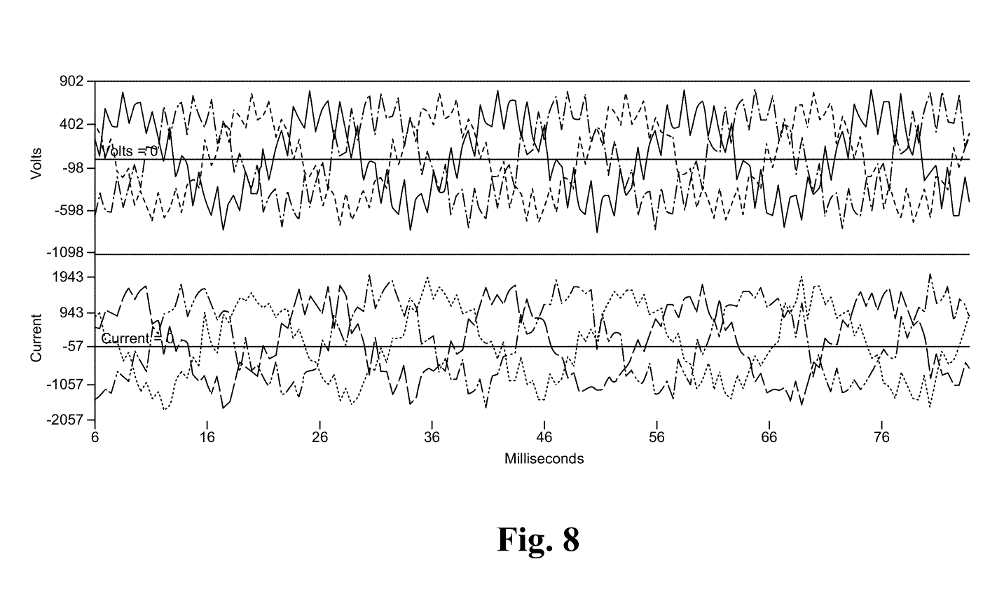

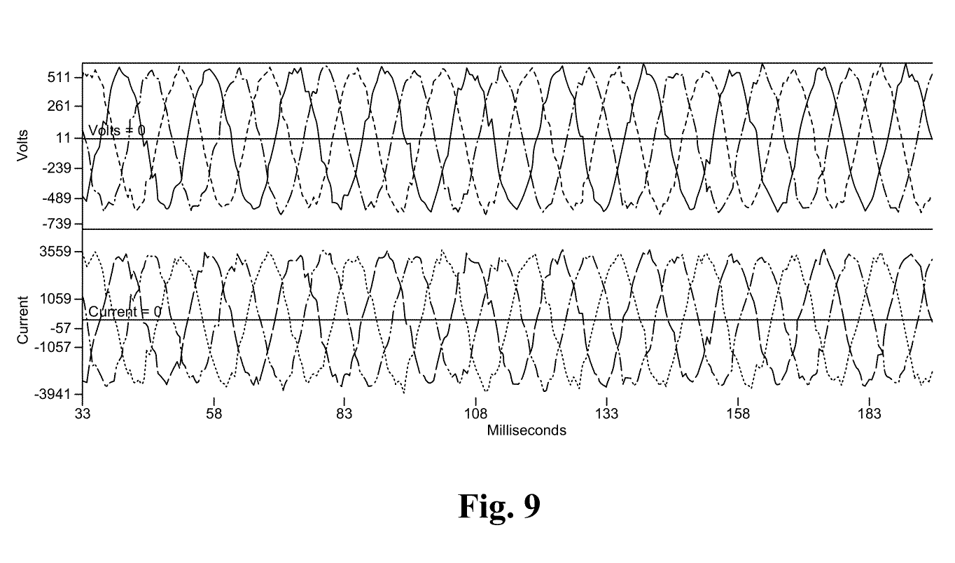

Referring back to FIG. 4, the controller 110 may alternatively be configured to operate according to the second actively damped approach of method 126, which aims to simulate the effects of passive damping as performed by the first approach using only active, electronic means and without actual use of damping resistors. In accordance with the second approach, the filter module 112 of the associated inverter system 110 may include undamped filter elements 120, such as inductors, or the like, rather than damping resistors, while the controller 110 may generally be configured to estimate trap filter currents based on the measured output phase signals or related grid parameters in step 126-5, and isolate harmonics based at least partially on the estimated trap filter currents in step 126-6. As shown in FIG. 10, for example, the AC current regulator or inverter control function 142 of the controller 110 may be provided with a full active damping control loop 144 configured to extract only distortions from the phase signals of the current regulator 142. The transfer function 146 used in the active damping control loop 144 may rely upon estimations rather than actual measurements of the trap filter currents. Estimations of the trap filter currents as well as the transfer function 146 may be derived based on further analyses, as shown for example in FIGS. 11-14.

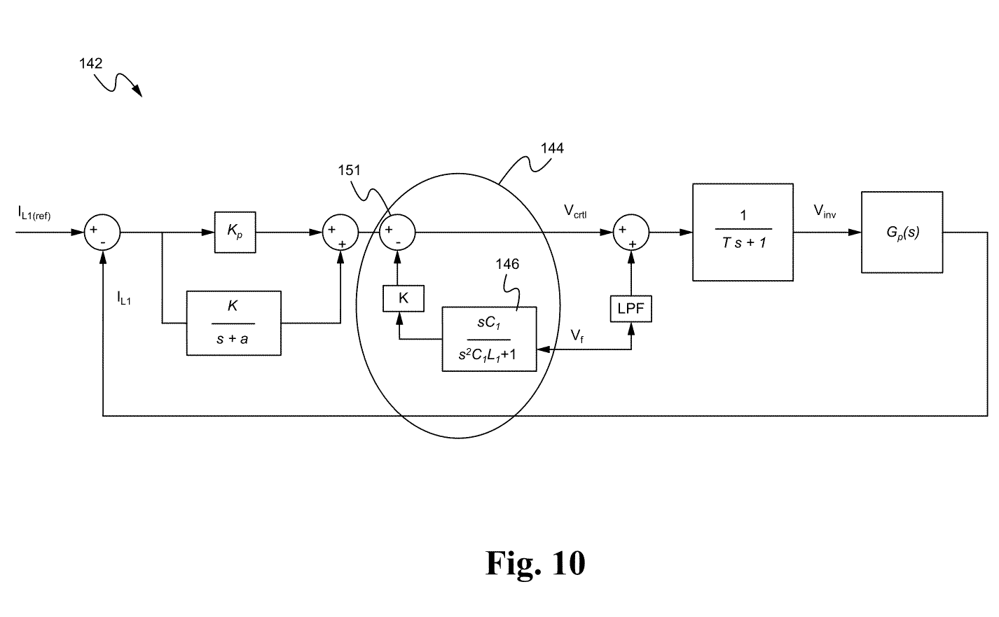

Turning to FIG. 11, the single-phase equivalent circuit 148 of an undamped passive filter may be modeled as shown, where inductor resistances are neglected, and where L₁ indicates the line reactor 116, L_{f} and C_{f} indicate the trap filter 118, and L_{g} indicates leakage from the PMT 114 and inductance from the grid 106. Furthermore, Vᵢₙᵥ indicates the inverter output phase voltage, V_{f} indicates the voltage of the trap filter 118, and V_{g} indicates the voltage of the grid 106. The single-phase equivalent circuit 148 of FIG. 11 may additionally be modeled as the undamped single-phase equivalent damping control function 150 shown in FIG. 12. Based on the damping control function 150 of FIG. 12, and assuming that the associated inverter system 100 is operating in a current-regulated pulse-width modulated (PWM) voltage-source mode of operation in which the line reactor current may be measured and controlled, as is common with full power conversion type wind turbines for instance, the plant transfer function may be derived to be

$$\begin{matrix}( \text{?} ) = \text{?} = \text{?} , \\ where & ( 1 ) \\ λ = \text{?} + \text{?} + \text{?} , \\ and & ( 2 ) \\ = \text{?} \\ \text{?} \text{indicates text missing or illegible when filed} & ( 3 )\end{matrix}$$

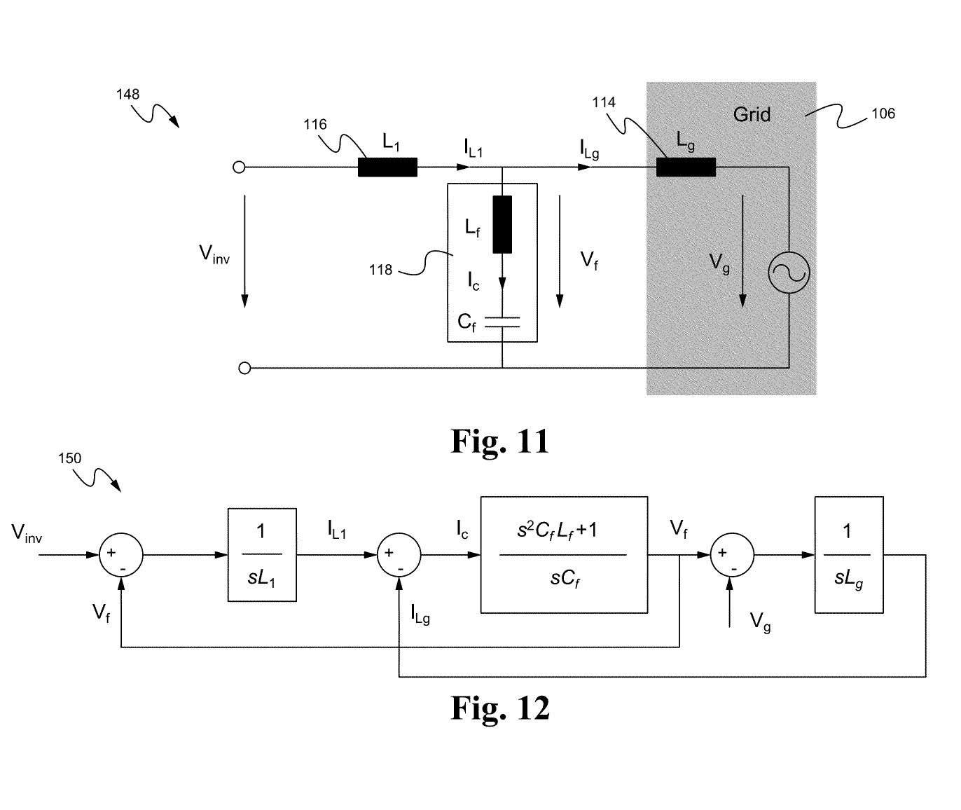

Furthermore, assuming a damping resistor R_{f} is applied to the single-phase equivalent circuit 148 as shown in FIG. 13, the plant transfer function in equation (1) above may be rewritten as

$$( \text{?} ) = \text{?} = \text{?} . \\ \text{?} \text{indicates text missing or illegible when filed} \qquad ( 4 )$$

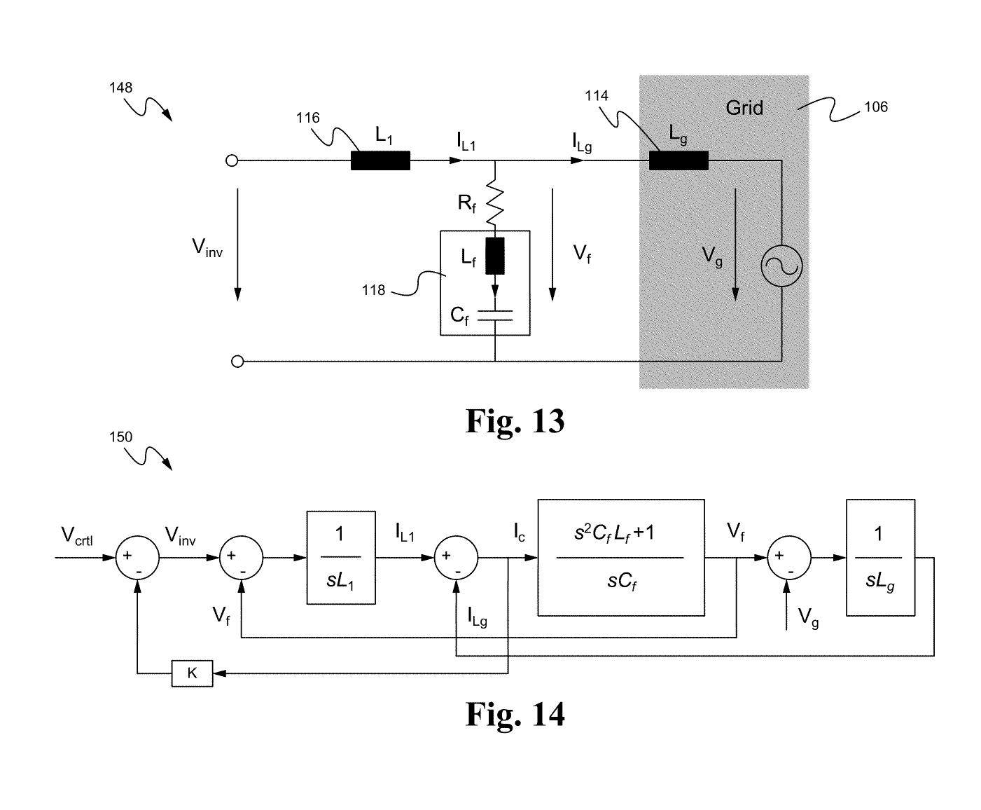

The passively damped plant transfer function of equation (4) may be effectively simulated without actually adding the damping resistor R_{f} by feeding the trap filter current back into the control function 150, as shown for example in FIG. 14, to result in the plant transfer function of

$$( \text{?} ) = \text{?} = \text{?} , \\ \text{?} \text{indicates text missing or illegible when filed} \qquad ( 5 )$$

where K indicates the damping gain. Thus, using voltage and/or current measurements taken from sensors 122, 124 disposed about the inverter 102 and the electrical grid 106, as well as known electrical relationships between the trap filters 118 and the associated single-phase equivalent circuit 148 of FIGS. 11 and 13, the controller 110 may be able to estimate the current flowing through the trap filters 118 in accordance with step 126-5 of FIG. 4. Furthermore, based on the estimated trap filter currents and the single-phase plant transfer function of equation (5), it may be possible to derive and configure the controller 110 with the combined three-phase inverter control function 142 of FIG. 10.

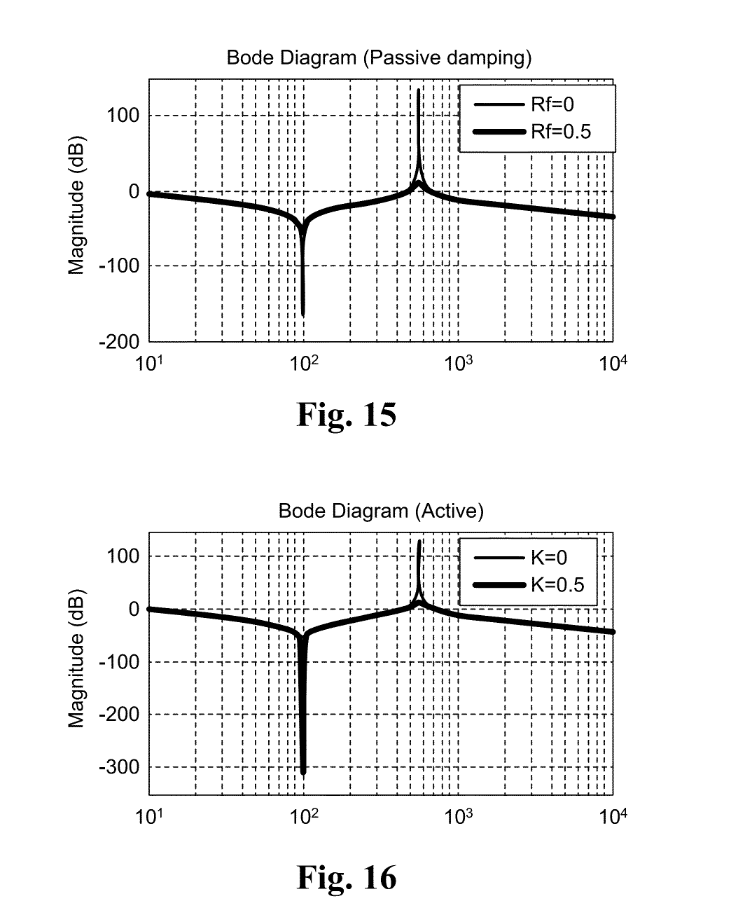

The performance of the passively damped, actively filtered inverter control function 128 of FIG. 5 may be compared to the performance of the actively damped inverter control function 142 of FIG. 10 by viewing the respective open loop magnitude plots as shown in FIGS. 15 and 16. For example, FIG. 15 may depict the Bode magnitude diagram of the passively damped, actively filtered inverter control function 128, while FIG. 16 may depict the corresponding Bode magnitude diagram of the actively damped inverter control function 142. As shown, for a damping gain K of approximately 0.5, the harmonics or resonance of an actively damped inverter system may be damped as effectively as a passively damped inverter system that is damped with an actual resistor of approximately 0.5Ω. Thus, the actively damped inverter control function 142 of FIG. 10 may configure the controller 110 of FIG. 3 to provide damping results similar to those of the passively damped and actively filtered inverter control function 128 of FIG. 5. Correspondingly, the controller 110 may employ the inverter control function 142 of FIG. 10 to perform step 126-6 of the second approach in FIG. 4 and proceed to isolate harmonics in a manner similar to that of a passively damped inverter system having comparable damping resistance. As with the passively damped approach, the controller 110 of an actively damped inverter system may then be configured to subtract the harmonics from the output phase signals in step 126-7, and operate the AC current regulator 128 based on the harmonic-free output phase signals in step 126-8. More specifically, the harmonics which have been isolated by the transfer function 146 in step 126-6 may be subtracted from the regulator control signal V_{ctrl} via the adder 151. The controller 110 may then use the newly adjusted control signal V_{ctrl} to operate the output of the AC current regulator 128 accordingly.

Thus, the present disclosure sets forth inverter systems and methods which effectively and efficiently provide damping of undesirable harmonics residing in the output of power-generating machines, such as wind turbines, solar panel systems, and the like. Specifically, the present disclosure provides multiple simplified approaches to substantially eliminating resonance frequencies caused by interactions between the filter elements of the inverter system and the associated electrical grid. The first approach of the present disclosure provides a combined passively damped and actively filtered solution which employs significantly reduced damping resistance to reduce heat loads by approximately half of that associated with conventional methods. Furthermore, the first approach is not dependent upon grid parameters, and additionally, provides improved stability against transient distortions and steady-state harmonics, not only situated around the plant resonant frequency as with conventional active damping methods, but all harmonics above the fundamental frequency. The second approach of the present disclosure provides an actively damped solution which similarly provides effective damping of harmonics but employs an estimation of trap filter current rather than direct measurements. As the second approach may be based on estimates rather than measurements of the trap filter currents, the inverter system 100 may be used without installing new sensors and related hardware configured to actively and directly measure the current through each trap filter, as with conventional active damping methods of the prior art. Overall, the present disclosure provides reliable solutions that can be incorporated into both baseline designs and/or retrofitted onto existing applications at minimal cost.

While only certain embodiments have been set forth, alternatives and modifications will be apparent from the above description to those skilled in the art. These and other alternatives are considered equivalents and within the spirit and scope of this disclosure and the appended claims.

We claim:

1. A method of damping harmonic output of an inverter, comprising the steps of:
receiving output phase signals from sensors disposed at an output of the inverter and on an associated electrical grid;
filtering the output phase signals using a low pass filter configured to extract a fundamental component from the output phase signals;
isolating harmonics from the output phase signals based on the extracted fundamental component; and
subtracting the harmonics from the output phase signals.

2. The method of claim 1, further comprising the step of operating an alternating current (AC) regulator of the inverter based on the harmonic-free output phase signals.

3. The method of claim 1, wherein trap filters associated with the inverter are damped with relatively small damping resistors.

4. The method of claim 3, wherein the damping resistors have a resistance approximately 50% less than that of conventional passively damped filters.

5. The method of claim 1, wherein the filtering and isolating steps further include:
transforming the output phase signals into a direct-quadrature (dq) reference signal;
filtering the dq reference signal to extract the fundamental component;
subtracting the fundamental component from the dq reference signal to isolate the harmonics in dq form;
transforming the dq harmonics back into output phase signals;
applying a predefined gain to the harmonics; and
subtracting the harmonics from an output of an associated current controller.

6. The method of claim 5, wherein the output phase signals are phase-shifted prior to each transforming step.

7. The method of claim 1, wherein the sensors provide one or more of output voltage and line reactor current, the sensors being disposed external to a filter module associated with the inverter, the filter module comprising at least trap filters and line reactors.

8. A method of damping harmonic output of an inverter, comprising the steps of:
receiving output phase signals from sensors disposed at an output of the inverter and on an associated electrical grid;
estimating trap filter currents based on the output phase signals;
isolating harmonics from the output phase signals based at least partially on the estimated trap filter currents; and
subtracting the harmonics from the output phase signals.

9. The method of claim 8, wherein the sensors provide one or more of output voltage and line reactor current, the sensors being disposed external to a filter module associated with the inverter, the filter module comprising at least trap filters and line reactors.

10. The method of claim 8, wherein trap filters associated with the inverter are undamped.

11. The method of claim 8, wherein the estimating and isolating steps further include:
generating a transfer function based on line reactor currents received from the sensors and the estimated trap filter currents;
configuring the transfer function to simulate passively damped trap filters;
applying the transfer function to isolate the harmonics from the output phase signals; and
applying a predefined gain to the harmonics.

12. The method of claim 8, further comprising the step of operating an alternating current (AC) regulator of the inverter based on the harmonic-free output phase signals.

13. A system for damping harmonic output, comprising:
an inverter having a plurality of output phases;
a filter module having line reactors and trap filters in communication with the output phases of the inverter;
a plurality of sensors configured to detect at least a voltage of each output phase; and
a controller in communication with the sensors and operatively coupled to the inverter, the controller being configured to isolate harmonics from each output phase signal, and subtract the harmonics from the corresponding output phase signals.

14. The system of claim 13, wherein the sensors are disposed on an associated electrical grid and external to the filter module.

15. The system of claim 13, wherein the controller is configured to filter the output phase signals using a low pass filter and extract a fundamental component from the output phase signals, the controller isolating the harmonics from the output phase signals based on the extracted fundamental component, the trap filters being damped with relatively small damping resistors.

16. The system of claim 15, wherein the controller while filtering and isolating:
transforms the output phase signals into a direct-quadrature (dq) reference signal;
filters the dq reference signal to extract the fundamental component;
subtracts the fundamental component from the dq reference signal to isolate the harmonics in dq form;
transforms the dq harmonics back into output phase signals;
applies a predefined gain to the harmonics; and
subtracting the harmonics from the controller output.

17. The system of claim 15, wherein the trap filters are damped with resistors having a resistance approximately 50% less than conventional passively damped filters.

18. The system of claim 13, wherein the controller is configured to estimate trap filter currents based on the output phase signals and isolate the harmonics from the output phase signals based at least partially on the estimated trap filter currents, the sensors being configured to further detect line reactor current, the trap filters being undamped.

19. The system of claim 18, wherein the controller while estimating and isolating:
generates a transfer function based on line reactor currents received from the sensors and the estimated trap filter currents;
configures the transfer function to simulate passively damped trap filters;
applies the transfer function to isolate the harmonics from the output phase signals; and
applies a predefined gain to the harmonics.

20. The system of claim 13, wherein the controller is further configured to operate an alternating current (AC) regulator of the inverter based on the resulting harmonic-free output phase signals.
